(19) United States
(12) Patent Application Publication
(10) Pub. No.: US 2014/0126988 A1
(43) Pub. Date: May 8, 2014

(54) Transportation System For Moving Flat Panel And Mechanical Apparatus Thereof And Method For Moving The Same

(71) Applicant: Shenzhen China Star Optoelectronics Technology Co. Ltd., Shenzhen, Guangdong (CN)

(72) Inventors: Minghu Qi, Shenzhen City (CN); Chunhao Wu, Shenzhen City (CN); Kunhsien Lin, Shenzhen City (CN); Yongqiang Wang, Shenzhen City (CN); Zhenhua Guo, Shenzhen City (CN); Weibing Yang, Shenzhen City (CN); Zenghong Chen, Shenzhen City (CN); Yunshao Jiang, Shenzhen City (CN); Zhiyou Shu, Shenzhen City (CN)

(73) Assignee: Shenzhen China Star Optoelectronics Technology Co. Ltd., Shenzhen, Guangdong (CN)

(21) Appl. No.: 13/700,708

(22) PCT Filed: Nov. 16, 2012
(86) PCT No.: PCT/CN12/84722

§ 371 Date: Nov. 28, 2012

(30) Foreign Application Priority Data
Nov. 2, 2012 (CN) 201210433792.2

(51) Int. Cl. B65G 49/06

(52) U.S. Cl. CPC B65G 49/061
USPC 414/752.1

(57) ABSTRACT

The present invention discloses a transportation system for moving a flat panel and a mechanical apparatus thereof and a method for moving the same. The mechanical apparatus comprising a mechanical arm and the mechanical arm comprise a first vacuum suction nozzle for sucking a first flat panel, a second vacuum suction nozzle for sucking a second flat panel, and a loop system connects to the first vacuum suction nozzle and the second vacuum suction nozzle. The first vacuum suction nozzle is disposed at a first position of the mechanical arm, and the second vacuum suction nozzle is disposed at a second position of the mechanical arm. The present invention can use one mechanical arm to carry and move two flat panels at the same time in order to increase the moving efficiency.

### BACKGROUND OF THE INVENTION

1. Field of the Invention

The present invention relates to transportation equipment, and more particularly relates to a transportation system for moving a flat panel and a mechanical apparatus thereof and a method for moving the same.

2. Description of Related Art

In industrial production, it often needs for moving production elements like flat panels or materials. For example, cutting in a production process to create the flat panels, and then moving them to another production process for cleaning or polishing. Finally, it moves to the third process to be assembled or next working, step.

Obviously, for this type of industrial production, increasing the moving efficiency of the flat panel and reducing the moving costs are very important. In the prior art, it generally use mechanical apparatus to carry and move the flat panel. However, the mechanical arm of the mechanical apparatus can only carry and move one flat panel at a time, its efficiency is relatively low. If it increases the number of the mechanical arms to early and move more flat panels, it will increase the cost of the mechanical apparatus.

### SUMMARY OF THE INVENTION

The technical problem solved by the embodiment of the present invention is to solve is to provide a transportation system for moving a flat panel and a mechanical apparatus thereof and a method for moving the same in order to solve the low moving efficiency and high cost problem.

In order to solve the above-mentioned technical problem, a technical solution provided by the present invention is: a transportation system for moving a flat panel comprising: a mechanical apparatus comprising a mechanical arm, and the mechanical arm comprises: at least one first vacuum suction nozzle disposed at a first position of the mechanical arm for sucking a first flat panel; at least one second vacuum suction nozzle disposed at a second position of the mechanical arm for sucking a second flat panel; a first control loop connecting to the first vacuum suction nozzle for controlling operation states of the first vacuum suction nozzle to become a vacuum state or a non-vacuum state; and a second control loop connecting to the second vacuum suction nozzle for controlling operation states of the second vacuum suction nozzle to become a vacuum state or a non-vacuum state; a supporting device comprising: a base; and multiple supporting pins disposed on the base for placing the first and the second flat panels; wherein, the multiple supporting pins are disposed at intervals to form spaces, and allowing the mechanical arm to enter and leave the spaces between the multiple supporting pins.

Wherein, the first control loop and the second control loop are independent.

Wherein, the number of the first vacuum suction nozzle is multiple, and the multiple first vacuum suction nozzles are disposed at intervals and not located in the same straight line; the number of the second vacuum suction nozzle is multiple, and the multiple second vacuum suction nozzles are disposed at intervals and not located in the same straight line.

Wherein, the mechanical arm comprises at least two spacing frames, and the multiple first vacuum suction nozzles are disposed on an upper surface of the frames, and the multiple second vacuum suction nozzles are disposed on a lower surface of the frames.

Wherein, the mechanical apparatus is a robot and the flat panel is a glass substrate.

In order to solve the above-mentioned technical problem, another technical solution provided by the present invention is: a mechanical apparatus for moving a flat panel, wherein, the mechanical apparatus comprises a mechanical arm, and the mechanical arm comprises: at least one first vacuum suction nozzle disposed at a first position of the mechanical arm for sucking a first flat panel; at least one second vacuum suction nozzle disposed at a second position of the mechanical arm for sucking a second flat panel; and a loop system connecting to the first vacuum suction nozzle and the second vacuum suction nozzle.

Wherein, the first position and the second position are respectively an upper surface and a lower surface of the mechanical arm.

Wherein, the loop system comprises: a first control loop connecting to the first vacuum suction nozzle for controlling operation states of the first vacuum suction nozzle to become a vacuum state or a non-vacuum state; and a second control loop connecting to the second vacuum suction nozzle for controlling operation states of the second vacuum suction nozzle to become a vacuum state or a non-vacuum state; wherein, the first control loop and the second control loop are independent.

Wherein, the number of the first vacuum suction nozzles is multiple, and the multiple first vacuum suction nozzles are disposed at intervals and not located in the same straight line; the number of the second vacuum suction nozzles is multiple, and the multiple second vacuum suction nozzles are disposed at intervals and not located in the same straight line.

Wherein, the mechanical arm comprises at least two spacing frames, and the multiple first vacuum suction nozzles are disposed on an upper surface of the frames, and the multiple second vacuum suction nozzles are disposed on a lower surface of the frames.

Wherein, the mechanical apparatus is a robot and the flat panel is a glass substrate.

In order to solve the above-mentioned technical problem, another technical solution provided by the present invention is: a method for moving a flat panel comprising: placing a first flat panel on top ends of multiple supporting pins disposed at intervals, and using a first vacuum suction nozzle at a first position of a mechanical arm to suck the first flat panel; placing a second flat panel on top ends of the multiple supporting pins, and using a second vacuum suction nozzle at a second position of the mechanical arm to suck the second flat panel; and using the mechanical arm to move the first and the second flat panels.

Wherein, in the step of placing a first flat panel on top ends of multiple supporting pins disposed at intervals, and using a first vacuum suction nozzle at a first position of a mechanical arm to suck the first flat panel comprises: placing the first flat panel on the top ends of the multiple supporting pins; inserting the mechanical arm from a side surface into spaces between the supporting pins such that the first vacuum suction nozzle is located, below the first flat panel, wherein the first position is provided on an upper surface of the mechanical arm; controlling the mechanical arm to move upward, and using the first vacuum suction nozzle to suck the first flat panel; and controlling the mechanical arm to continue moving to a predetermined region above the supporting pins.

Wherein, in the step of placing a second flat panel on top ends of the multiple supporting pins, and using a second vacuum suction nozzle at a second position of the mechanical arm to suck the second flat panel comprises: placing the second flat panel on the top ends of the multiple supporting pins; and controlling the mechanical arm to move downward from the predetermined region, and using the second vacuum suction nozzle to suck the second flat panel, wherein the second position is provided on a lower surface of the mechanical arm.

In the present invention, the mechanical arm provides with the first vacuum suction nozzle and the second vacuum suction nozzle at different positions. And utilizing the first vacuum suction nozzle to suck the first flat panel and the second vacuum suction nozzle to suck the second flat panel so that the mechanical apparatus can use one mechanical arm to suck at least two flat panels at a time in order to greatly increase the moving efficiency of the flat panel and save the cost for providing additional mechanical arms.

### BRIEF DESCRIPTION OF THE DRAWINGS

FIG. 1 is a schematic view of a mechanical arm of a mechanical apparatus according to an embodiment of the present invention;

FIG. 2 is a top view of the mechanical arm of the mechanical apparatus shown in FIG. 1;

FIG. 3 is a schematic view of a supporting device of the transportation system of the present invention, wherein, a first flat panel is placed on the supporting device;

FIG. 4 is a first flowchart of the transportation system in working process of the present invention, wherein the mechanical arm is located below the first flat panel;

FIG. 5 is a second flowchart of the transportation system of the present invention, wherein the mechanical arm removes the first flat panel and locates at a predetermined region above the supporting pins;

FIG. 6 is a third flowchart of the transportation system of the present invention, wherein the mechanical arm is located at the predetermined region above the supporting pins and a second flat panel is placed on the supporting device;

FIG. 7 is a fourth flowchart of the transportation system of the present invention, wherein the mechanical arm sucks the second flat panel;

FIG. 8 is a flowchart of the method for moving the flat panel of the present invention;

FIG. 9 is a flowchart of the step S100 of the method shown in FIG. 8; and

FIG. 10 is a flowchart of the step S200 of the method shown in FIG. 8.

### DETAILED DESCRIPTION ION OF THE PREFERRED EMBODIMENT

The following content combines drawings and embodiments for detail description of the present invention.

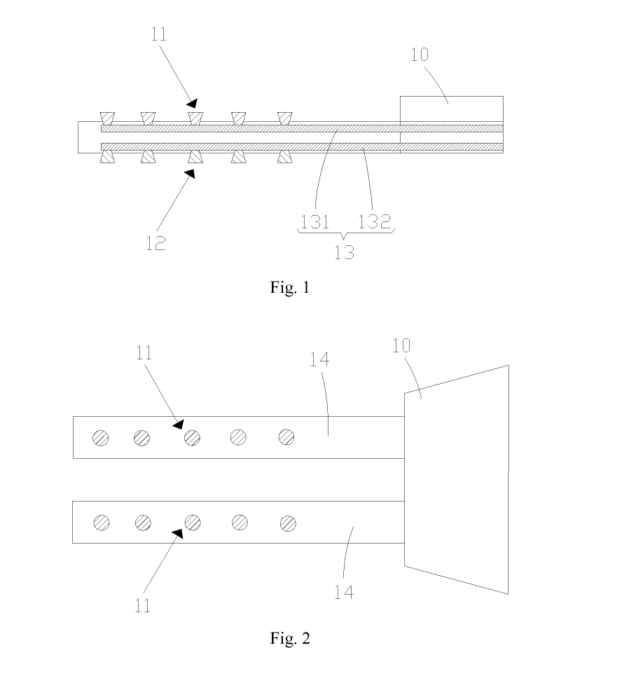

With reference to FIG. 1 and FIG. 2, in the present embodiment, a mechanical apparatus for carrying a flat panel includes at least one mechanical arm 10, wherein the mechanical apparatus may be a robot or other devices such as a van or a crane. Since the detail content is well known to the person skilled in the art, it will not repeat again. The following will describe specific structure of the mechanical arm 10 in detail.

In the present embodiment, the mechanical arm 10 includes at least one first vacuum suction nozzle 11, and at least one second vacuum suction nozzle 12, and a loop system 13. Wherein the first vacuum suction nozzle 11 located at a first position of the mechanical arm 10 for the sucking a first flat panel; the second vacuum suction nozzle 12 is located at a second position of the mechanical arm 10 for sucking a second flat panel; the loop system 13 connects to the first vacuum suction nozzle 11 and the second vacuum suction nozzle 12.

It is easy to understand that the function of the vacuum suction nozzle is for sucking the flat panel so that mechanical apparatus can pick, place, carry and move the flat panel by the mechanical arm 10. Since this part of the contents is easily understand by the person skilled in the art, it will not describe in detail. It is worth mentioning that the invention will not limit the specific structure of the vacuum suction nozzle (such as the size or shape, etc.).

Obviously, by disposing the first vacuum suction nozzle 11 at the first position and the second vacuum suction nozzle 12 at the second position, the mechanical apparatus can carry and move at least two flat panels simultaneously by utilizing one mechanical arm 10 such that it can greatly increase, the transportation efficiency and the cost produced by adding the number of the mechanical arm 10.

If the condition is allowed, for example, the volume of the mechanical arm 10 is larger, the person skilled in the art can also dispose a third vacuum suction nozzle at a third position according to requirement, or even dispose a fourth vacuum suction nozzle at a fourth position etc. And make the mechanical arm 10 carry more flat panels in the premise without creative effort, the disposition and the number of vacuum suction nozzles considered by the person skilled in the art is still belong to the scope of the claims of the present invention.

Specifically, in the present embodiment, the first and second positions are respectively the upper and the lower surfaces of the mechanical arm 10. In other words, the first vacuum suction nozzle 11 is located at the upper surface of the mechanical arm 10, and the second vacuum suction nozzle 12 is located at the lower surface of the mechanical arm 10. Of course, in other embodiments, the first and second positions can be flexibly adjusted, for example, the first and second positions are all located at the upper or lower surface, and the present invention will not limit it.

Furthermore, the number of the first vacuum suction nozzles 11 is multiple. Preferably, the multiple first vacuum suction nozzles 11 are disposed at intervals and not located in the same straight line. Similarly, the number of the second vacuum suction nozzles 12 is multiple. Preferably, the multiple second vacuum suction nozzles 12 are disposed at intervals and not located in the same straight line. When utilizing the vacuum suction nozzles to suck and fix the flat panel, with compared to locate in parallel, the multiple vacuum suction nozzles which are not located at the same straight line (such as the three vacuum suction nozzles located in vertices of a triangle) can achieve a better effect.

For example, in FIG. 2, the mechanical arm 10 is provided with ten first vacuum suction nozzles 11, and is divided into two rows (each row has five). It is worth mentioning that in FIG. 2, it only shows an arrangement way for the first vacuum suction nozzles 11. The person skilled in the art can completely utilize other arrangement ways. For example, the multiple first vacuum suction nozzles 11 are arranged in a circle configuration, etc. The present invention will not limit it.

Since the arrangement of the second vacuum suction nozzles 12 is similar to the arrangement of the first vacuum suction nozzles 11 so that it can understand the relative features through the above description. The present invention will not repeat again.

In the present embodiment, the mechanical arm 10 may also include at least two spacing frames 14. The multiple first vacuum suction nozzles 11 are disposed at the upper surface of the frames 14. The multiple second vacuum suction nozzles 12 are disposed at the lower surface of the frames 14. Of course, in other embodiments, the person skilled in the art can also dispose one, three or four frames 14 according to requirement; the present invention does not specifically limit them.

It is worth mentioning that the frames 14 are not limited to rectangles shown in FIG. 2 of the present invention. The person skilled in the art can flexibly dispose them according to requirement, such as an arc shape in order to arrange the vacuum suction nozzles to not locate in the same straight line.

In the present embodiment, the loop system 13 comprises a first control loop 131 and a second control loop 132. Wherein, the first control loop 131 connects to the first vacuum suction nozzle 11 for controlling, operation states of the first vacuum suction nozzle 11 to become a vacuum state or a non-vacuum state. The second control loop 132 connects to the second vacuum suction nozzle 12 for controlling operation states of the second vacuum suction nozzle 12 to become a vacuum state or a non-vacuum state. Using the loop system 13 to achieve control of the vacuum suction nozzles can easily be understood by the person skilled in the art. The present invention will not repeat again.

In the present embodiment, the first control loop 131 and the second control loop 132 are independent. That is, they are controlled independently so that the first vacuum suction nozzle 11 and the second vacuum, suction nozzle 12 are also controlled independently. Thus, when using the first vacuum suction nozzle 11 for suction, it does not require controlling the second vacuum suction nozzle 12, and vice versa. In actual operation, the independent control can greatly increase the flexibility and convenience, and also avoids unwanted operation.

In the present embodiment, the flat panel can be a glass substrate or other types of panels. In addition, the mechanical apparatus of the present invention can be used for moving the flat panel or applied in other fields, and the present invention will not limit it.

Through disposing the first vacuum suction nozzle 11 and the second vacuum suction nozzle 12 respectively at the first position and the second position of the mechanical arm 10, and using the first vacuum suction nozzle 11 for sucking, the first flat panel, and using the second vacuum suction nozzle 12 for sucking the second flat panel. The mechanical apparatus in the present embodiment can utilize one mechanical arm 10 for simultaneously carrying and moving the at least two flat panel. Therefore, it greatly increases the moving efficiency. In addition, compared with the conventional mechanical apparatus provided with multiple mechanical arms 10, the present invention can also reduce the cost.

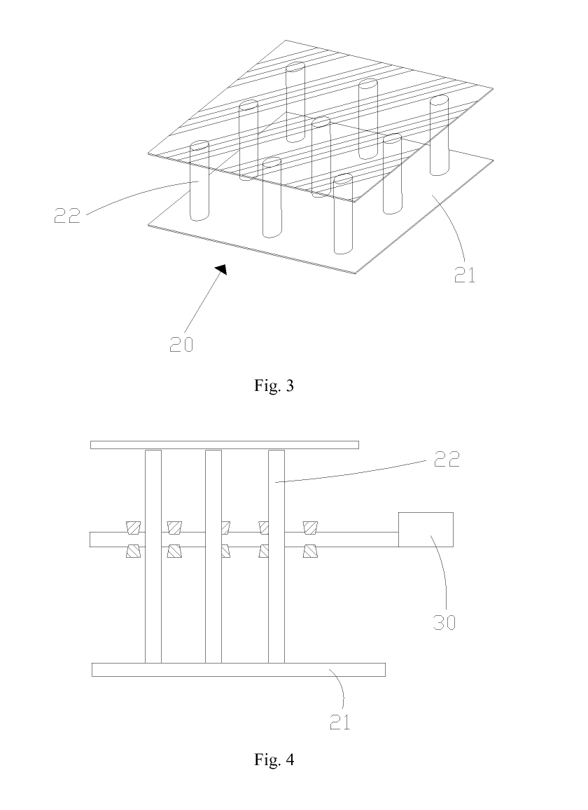

With reference to FIG. 3 and FIG. 4, in the present embodiment, the transportation system for moving the flat panel also includes a supporting device 20 and a mechanical apparatus 10. It should be noted that, in the present embodiment, the mechanical apparatus 10 includes at least one mechanical arm 30.

Specifically, the supporting device 20 includes a base 21 and multiple supporting pins 22. The multiple supporting pins 22 are disposed on the base 21 for placing the flat panels. In the present embodiment, the multiple supporting pins 22 are disposed at intervals to allow the mechanical arm 30 entering and leaving the spaces between the supporting pins 22. It is easy to understand that the mechanical arm. 30 of the mechanical apparatus can insert at the spaces between the supporting pins 22 in order to complete the suction process in the next step.

For better understanding the working process of the transportation system, the following content combines FIG. 4 to FIG. 7 for detail description.

With reference to FIG. 4 through FIG. 7. Firstly; in FIG. 4, the mechanical arm 30 is inserted into the spaces between the supporting pins 22 so that the vacuum suction nozzles on the upper surface are located below a first flat panel.

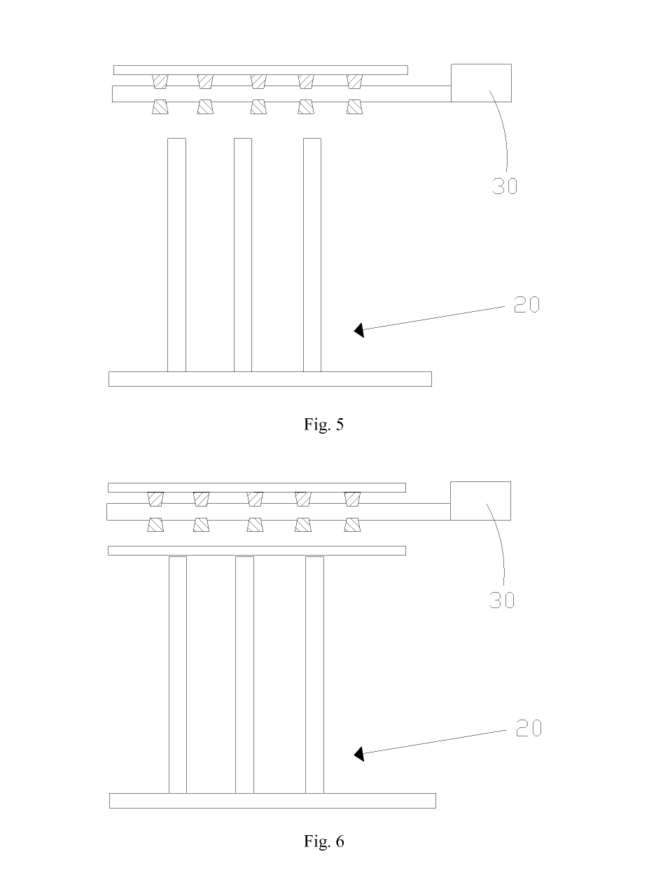

Secondly, in FIG. 5, the mechanical arm 30 moves upward to suck the first flat panel using the vacuum suction nozzles on the upper surface. At the same time, after the completion of the suction action, the mechanical arm 30 continues to move to a predetermined region above the supporting pins 22.

Next, in FIG. 6, the mechanical arm 30 is waiting at the predetermined region, when a second flat panel is placed on the supporting pins 22.

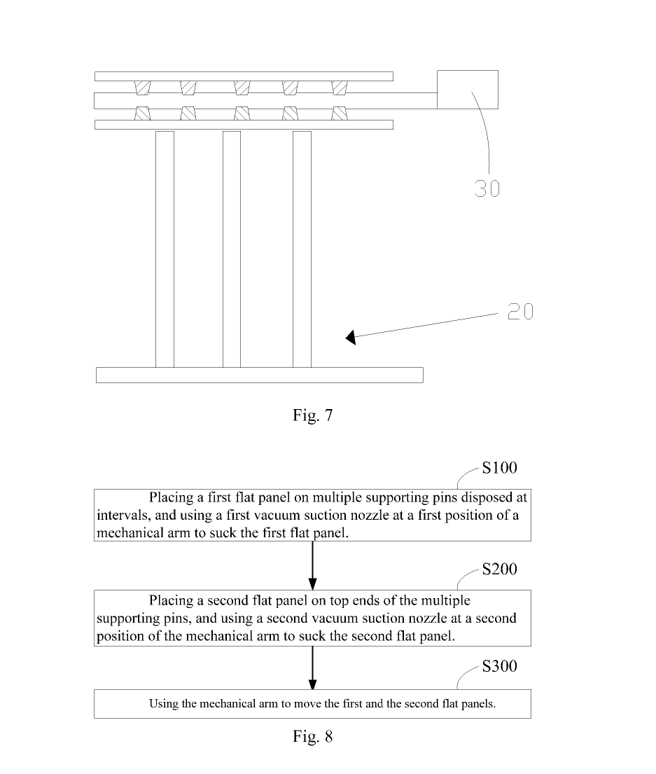

Finally, in FIG. 7, the mechanical arm 30 moves downward from the predetermined region to suck the second flat panel using the vacuum suction nozzles on the lower surface.

By the above steps, the mechanical arm 30 can early two flat panels at a time such that it can greatly increase the moving efficiency of the mechanical apparatus. Furthermore, with compared to the conventional art using two mechanical arms to carry two flat panels, the present invention can save the cost for adding mechanical arms

It is easy to understand, in, the above steps, the person skilled in the art can control the operation states of the vacuum suction nozzles to become the vacuum state or the non-vacuum state using the loop system at the appropriate time according to requirement. Because it belongs to common means of the field of the present invention, the present invention will not repeat again.

As to how to put down the two flat panels at the mechanical arm 30, it only needs opposite steps. Firstly, placing the second flat panel at the lower surface on the supporting pins 22, and waiting the second flat panel to be removed. Then, inserting the mechanical arm. 30 into the spaces between the supporting pins 22 and placing the first flat panel on the supporting pins 22. Finally, removing the mechanical arm 30.

In the present embodiment, through the cooperation of the mechanical arm 30 provided with the vacuum suction nozzles on the upper and lower surfaces and the supporting device 20, and using predetermined steps and processes, the mechanical apparatus can use one mechanical arm. 30 for carrying and moving the two flat panels at the same time. Therefore, it greatly increases the moving efficiency of the transportation system.

With reference to FIG. 8, the present embodiment provides a transportation method for a flat panel. The method includes the following steps:

S100: Placing a first flat panel on multiple supporting pins disposed at intervals, and using a first vacuum suction nozzle at a first position of a mechanical arm to suck the first flat panel.

S200: Placing a second flat panel on top ends of the multiple supporting pins, and using a second vacuum suction nozzle at a second position of the mechanical arm to suck the second flat panel.

S300: Using the mechanical arm to move the first and the second flat panels.

Combining the description relative to the apparatus above, especially the introduction of the working process of the transportation system in the previous embodiment, the person skilled in the art is very easy to understand the related content of the method, and it will not repeat again.

It is worth mentioning that the above steps do not need to perform in strict order, for example, if the supporting pins are large enough, it can directly place two flat panels on them. Then, according the similar method for successively sucking, the present invention will not limit it.

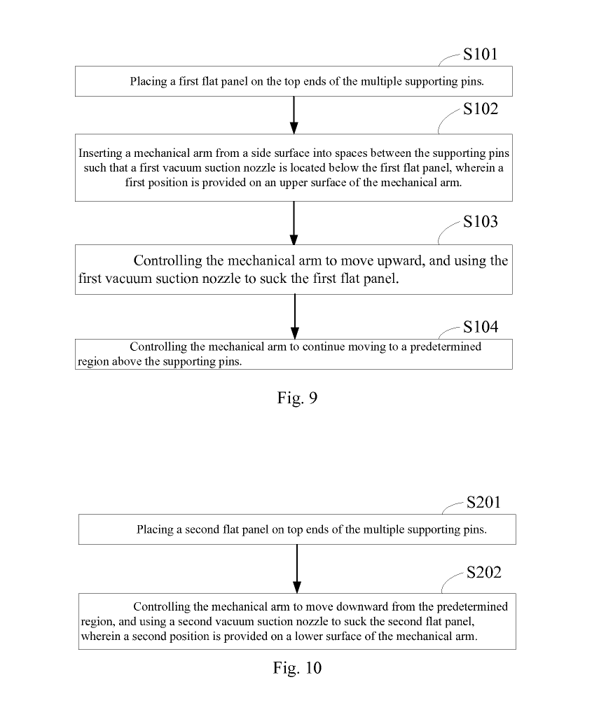

With reference to FIG. 9, in another embodiment, the step S100 further includes the following steps.

S101: Placing a first flat panel on the top ends of the multiple supporting pins.

S102: Inserting a mechanical arm from a side surface into spaces between the supporting, pins such that a first vacuum suction nozzle is located below the first flat panel, wherein a first position is provided on an upper surface of the mechanical arm.

S103: Controlling the mechanical arm to move upward, and using the first vacuum suction nozzle to suck the first flat panel.

S104: Controlling the mechanical arm to continue moving to a predetermined region above the supporting pins.

Similarly, with reference to FIG. 10, in another embodiment, the step S200 can further include the following steps:

S201: Placing a second flat panel on top ends of the multiple supporting pins.

S202: Controlling the mechanical arm to move downward from the predetermined region, and using a second vacuum suction nozzle to suck the second flat panel, wherein a second position is provided on a lower surface of the mechanical arm.

In the transportation method for the flat panel, the mechanical arm provides with the first vacuum suction nozzle at the first position and the second vacuum suction nozzle at the second position so that the mechanical arm can successively and respectively use the first vacuum suction nozzle and the second vacuum suction nozzle to suck the two flat panels at a time. The above method can greatly increase the moving efficiency of the flat panel, and it can save the cost for providing additional mechanical arms.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A transportation system for moving a flat panel comprising:
a. mechanical apparatus comprising a mechanical arm, and the mechanical arm comprises:
at least one first vacuum suction nozzle disposed at a first position of the mechanical arm for sucking a first flat panel;
at least one second vacuum suction nozzle disposed at a second position of the mechanical arm for sucking a second flat panel;
a first control loop connecting to the first vacuum suction nozzle for controlling operation states of the first vacuum suction nozzle to become a vacuum state or a non-vacuum state; and
a second control loop connecting to the second vacuum suction nozzle for controlling operation states of the second vacuum suction nozzle to become a vacuum state or a non-vacuum state;
a supporting device comprising:
a base; and
multiple supporting pins disposed on the base for placing the first and the second flat panels;
wherein, the multiple supporting pins are disposed at intervals to form spaces, and allowing the mechanical arm to enter and leave the spaces between the multiple supporting pins.

2. The transportation system according to claim 1, wherein, the first control loop and the second control loop are independent.

3. The transportation system according to claim 2, wherein, the number of the first vacuum suction nozzle is multiple, and the multiple first vacuum suction nozzles are disposed at intervals and not located in the same straight line; the number of the second vacuum suction nozzle is multiple, and the multiple second vacuum suction nozzles are disposed at intervals and not located in the same straight line.

4. The transportation system according to claim 3, wherein, the mechanical arm comprises at least two spacing frames, and the multiple first vacuum suction nozzles are disposed on an upper surface of the frames, and the multiple second vacuum suction nozzles are disposed on a lower surface of the frames.

5. The transportation system according to claim 4, wherein, the mechanical apparatus is a robot and the flat panel is a glass substrate.

6. A mechanical apparatus for moving a flat panel, wherein, the mechanical apparatus comprises a mechanical arm and the mechanical arm comprises:
at least one first vacuum suction nozzle disposed at a first position of the mechanical arm for sucking a first flat panel;
at least one second vacuum suction nozzle disposed at a second position of the mechanical arm for sucking a second flat panel; and
a loop system connecting to the first vacuum suction nozzle and the second vacuum suction nozzle.

7. The mechanical apparatus according to claim 6, wherein, the first position and the second position are respectively an upper surface and a lower surface of the mechanical arm.

8. The mechanical apparatus according to claim 6, wherein, the loop system comprises:
a first control loop connecting to the first vacuum suction nozzle for controlling operation states of the first vacuum suction nozzle to become a vacuum state or a non-vacuum state; and
a second control loop connecting to the second vacuum suction nozzle for controlling operation states of the second vacuum suction nozzle to become a vacuum state or a non-vacuum state;
wherein, the first control loop and the second control loop are independent.

9. The mechanical apparatus according to claim 6, wherein, the number of the first vacuum suction nozzles is multiple, and the multiple first vacuum suction nozzles are disposed at intervals and not located in the same straight line; the number of the second vacuum suction nozzles is multiple, and the multiple second vacuum suction nozzles are disposed at intervals and not located in the same straight line.

10. The mechanical apparatus according to claim 9, wherein, the mechanical arm comprises at least two spacing frames and the multiple first vacuum suction nozzles are disposed on an upper surface of the frames, and the multiple second vacuum suction nozzles are disposed on a lower surface of the frames.

11. The mechanical apparatus according to claim 6, wherein, the mechanical apparatus is a robot and the flat panel is a glass substrate.

12. A method for moving a flat panel comprising:
placing a first flat panel on top ends of multiple supporting pins disposed at intervals, and using a first vacuum suction nozzle at a first position of a mechanical arm to suck the first flat panel;
placing a second flat panel on top ends of the multiple supporting pins, and using a second vacuum suction nozzle at a second position of the mechanical arm to suck the second flat panel; and
using the mechanical arm to move the first and the second flat panels.

13. The method according to claim 12, wherein, in the step of placing a first flat panel on top ends of multiple supporting pins disposed at intervals, and using a first vacuum suction nozzle at a first position of a mechanical arm to suck the first flat panel comprises:
placing the first flat panel on the top ends of the multiple supporting pins;
inserting the mechanical arm from a side surface into spaces between the supporting pins such that the first vacuum suction nozzle is located below the first flat panel, wherein the first position is provided on an upper surface of the mechanical arm;
controlling the mechanical arm to move upward, and using the first vacuum suction nozzle to suck the first flat panel; and
controlling the mechanical arm to continue moving to a predetermined region above the supporting pins.

14. The method according to claim 13, wherein, in the step of placing a second flat panel on top ends of the multiple supporting pins, and using a second vacuum suction nozzle at a second position of the mechanical arm to suck the second flat panel comprises:
placing the second flat panel on the top ends of the multiple supporting pins; and
controlling the mechanical arm to move downward from the predetermined region, and using the second vacuum suction nozzle to suck the second flat panel, wherein the second position is provided on a lower surface of the mechanical arm.
